(19) United States
(12) Patent Application Publication
(10) Pub. No.: US 2026/0267111 A1
(43) Pub. Date: Sep. 10, 2026

(54) OPTICAL SYSTEMS AND METHODS OF THERMALLY REGULATING OPTICAL SYSTEMS

(71) Applicant: EVOLUTION OPTIKS LIMITED, Christ Church (BB)

(72) Inventors: Raul MIHALI, Westport, CT (US); Mostafa DARVISHI, Brossard (CA); Roman Perez GARCIA, Montreal (CA); Thomas Alberto RODRIGUEZ TORRES, Montreal (CA)

(21) Appl. No.: 19/166,254

(22) PCT Filed: Feb. 26, 2024
(86) PCT No.: PCT/IB2024/051830

§ 371 Date: Sep. 17, 2025

Related U.S. Application Data
(60) Provisional application No. 63/490,955, filed on Mar. 17, 2023.

(51) Int. Cl. G02B 7/02; G02B 3/14

(52) U.S. Cl. CPC G02B 7/028; G02B 3/14

(57) ABSTRACT

Described are various embodiments of optical systems, methods of thermally regulating optical systems, uses of thermal regulation systems in optical systems and non-transitory computer-readable mediums having computer-executable instructions stored thereon to modulate the thermal regulation systems of optical systems. Embodiments generally include selectively activating an active heat transfer device to transfer heat away from tunable refractive optical element via a thermal transfer chain to favourably maintain the tunable refractive optical element within a designated thermal operating range.

### FIELD OF THE DISCLOSURE

The present disclosure relates to thermal regulation of optical systems and in particular, to optical systems, methods of thermally regulating optical systems, uses of thermal regulation systems in optical systems and non-transitory computer-readable mediums having computer-executable instructions stored thereon to modulate the thermal regulation systems of optical systems.

### BACKGROUND

Thermal regulation devices and systems are known in the art, and used to maintain operational temperatures within a designated operational range.

Thermoelectric cooling devices, also known as Peltier devices, typically include two plates separated by P-and N-type semiconductor pillars, such that when electric current flows through the device, heat is transferred from one plate to the other. A heat sink typically engages the warm plate to maintain the ambient temperature whilst the cool plate provides a temperature lower than ambient temperature. Whilst Peltier devices are typically implemented as cooling devices, reversed current provides thermoelectric heating in some applications.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for optical systems and methods of thermally regulating optical systems that overcome some of the drawbacks of known techniques, or at least, provides a useful alternative thereto. Some aspects of this disclosure provide examples of such optical systems, methods of thermally regulating optical systems, uses of thermal regulation systems in optical systems and non-transitory computer-readable mediums having computer-executable instructions stored thereon to modulate thermal regulation systems of optical systems.

In accordance with one aspect, there is provided an optical system comprising: a casing defining an optical channel therethrough; a tunable refractive optical element mounted within said casing to apply a tunable refraction along said optical channel, wherein said tunable refractive optical element is favourably operable within a designated thermal operating range; and a thermal regulation system, comprising: an active heat transfer device; a thermally conductive element dimensioned to at least partially contact said tunable refractive optical element in thermal coupling therewith; and a thermal transfer conduit thermally coupled between said active heat transfer device and said thermally conductive element; wherein said active heat transfer device is activated to selectively transfer heat from said tunable optical refraction element via said thermally conductive element and said thermal transfer conduit to said active heat transfer device so as to maintain favourable operation of said tunable refractive optical element within said designated thermal operating range.

In one embodiment, the active heat transfer device is located within said casing at a distance from said tunable refractive optical element.

In one embodiment, the tunable refractive optical element is substantially cylindrically shaped and dimensioned and said thermally conductive element is complementarily shaped and dimensioned to at least partially circumscribe same.

In one embodiment, the tunable refractive optical element comprises a tunable lens.

In one embodiment, the tunable lens comprises a tunable liquid lens.

In one embodiment, the thermal transfer conduit comprises a fluid-circulating conduit.

In one embodiment, the thermal transfer conduit comprises a thermally conductive pipe or rod.

In one embodiment, the thermal transfer conduit is arranged along said optical channel of said casing.

In one embodiment, the active heat transfer device comprises a thermoelectric cooling device.

In one embodiment, the thermoelectric cooling device comprises a Peltier device having a heat absorption plate and a heat dissipation plate separated by a semiconductor layer.

In one embodiment, the heat absorption plate is arranged in thermal contact with said thermal transfer conduit.

In one embodiment, the active heat transfer device further comprises a fan arranged proximate said heat dissipation plate to facilitate heat dissipation.

In one embodiment, the active heat transfer device further comprises a heat sink arranged between said heat dissipation plate and said fan.

In one embodiment, the fan is located at a distance from said tunable refractive optical element.

In one embodiment, the active heat transfer device comprises liquid cooling device.

In one embodiment, the thermal regulation system further comprises a temperature sensor configured to measure any one or both of a current operating temperature of said tunable refractive optical element and a casing temperature proximate said tunable refractive optical element.

In one embodiment, the system further comprises a control unit operable to activate and/or deactivate said thermal regulation system to maintain a current operating temperature of said tunable refractive optical element within said designated thermal operating range.

In one embodiment, the control unit is operable to activate and/or deactivate said thermal regulation system in accordance with a predefined thermal cycle.

In one embodiment, the predefined thermal cycle is based on said designated thermal operating range and any one or both of: an expected casing operational temperature range and an expected ambient temperature range.

In one embodiment, the control unit is operable to activate or deactivate said thermal regulation system based at least in part on a sensed operational temperature received from a temperature sensor, said sensed operational temperature comprising any one or both of a current operating temperature of said tunable refractive optical element and a casing temperature proximate said tunable refractive optical element.

In one embodiment, the optical channel comprises a viewing channel to an active digital display.

In one embodiment, the tunable refractive optical element variably refracts pixelated content projected by said active digital display.

In one embodiment, hardware associated with said active digital display in use produces heat within said casing and said thermal regulation system at least partly compensates for operational heat generation.

In one embodiment, the optical system comprises a light field refractor.

In accordance with another aspect, there is provided a method of thermally regulating an optical system having a casing and a tunable refractive optical element mounted within the casing, the tunable refractive optical element being favourably operable within a designated thermal operating range, comprising: arranging a thermally conductive element to at least partially thermally contact the tunable refractive optical element; arranging an active heat transfer device at a distance from the tunable refractive optical element; thermally coupling a thermal transfer conduit between said active heat transfer device and said thermally conductive element; and automating selective activation said active heat transfer device to transfer heat from said tunable optical refraction element via said thermally conductive element and said thermal transfer conduit to said active heat transfer device to maintain favourable operation of said tunable refractive optical element within said designated thermal operating range.

In one embodiment, the active heat transfer device comprises a thermoelectric Peltier cooling device having a heat absorption plate and a heat dissipation plate separated by a semiconductor layer, and a heat sink abutting said heat dissipation plate.

In one embodiment, thermally coupling said thermal transfer conduit comprises thermally coupling said thermal transfer conduit to said heat absorption plate.

In one embodiment, the method further comprises arranging a fan proximate any one or both of said heat dissipation plate and said heat sink to facilitate heat dissipation.

In one embodiment, the fan is positioned at a distance from the tunable refractive optical element.

In one embodiment, arranging said thermally conductive element to at least partially thermally contact the tunable refractive optical element comprises at least partially circumscribing a substantially cylindrical shaped and dimensioned tunable refractive optical element with a complementarily shaped and dimensioned thermally conductive element.

In one embodiment, the active heat transfer device comprises liquid cooling device.

In one embodiment, the method further comprises arranging a temperature sensor within the casing and configuring said temperature sensor to measure any one or both of: a current operating temperature of the tunable refractive optical element and a casing temperature proximate the tunable refractive optical element.

In one embodiment, the
method comprises configuring a control unit within the casing to automatically activate and/or deactivate said active heat transfer device to maintain a current operating temperature of the tunable refractive optical element within the designated thermal operating range.

In one embodiment, the configuring said control unit comprises programming said control unit to activate and/or deactivate said active heat transfer device in accordance with a predefined thermal cycle.

In one embodiment, the predefined thermal cycle is based on the designated thermal operating range and any one or both of: an expected casing operational temperature range and an expected ambient temperature range.

In one embodiment, the configuring said control unit comprises: configuring said control unit to receive from a temperature sensor within the casing a sensed operational temperature; and programming said control unit to activate and/or deactivate said active heat transfer device in accordance with said sensed operational temperature.

In one embodiment, the sensed operational temperature comprises any one or both of a current operating temperature of the tunable refractive optical element and a casing temperature proximate the tunable refractive optical element.

In one embodiment, the casing defines an optical channel therethrough, the tunable refractive optical element is operable to apply a tunable refraction along said optical channel and said active heat transfer device is located within said casing at a distance from the tunable refractive optical element.

In one embodiment, the tunable refractive optical element comprises a tunable liquid lens.

In one embodiment, the thermal transfer conduit comprises any one or both of a fluid-circulating conduit and a thermally conductive pipe or rod.

In one embodiment, the thermal transfer conduit is arranged along said optical channel of the casing.

In one embodiment, the optical channel comprises a viewing channel to an active digital display.

In one embodiment, the tunable refractive optical element variably refracts pixelated content projected by said active digital display.

In one embodiment, hardware associated with said active digital display in use produces heat within the casing and wherein said active heat transfer device at least partly compensates for operational heat generation.

In one embodiment, the optical system comprises a light field refractor or phoropter.

In accordance with another aspect, there is provided use of a thermal regulation system in an optical system to selectively transfer heat from a tunable refractive optical element mounted within a casing to an active heat transfer device to maintain favourable operation of said tunable refractive optical element within a designated thermal operating range.

In one embodiment, the thermal regulation system comprises a thermally conductive element in thermal contact with said tunable refractive optical element.

In one embodiment, the thermal regulation system comprises a thermal transfer conduit thermally coupled between said active heat transfer device and said thermally conductive element.

In one embodiment, the tunable refractive optical element comprises a tunable liquid lens.

In one embodiment, the active heat transfer device comprises a thermoelectric cooling device.

In one embodiment, the thermoelectric cooling device comprises a Peltier device having a heat absorption plate and a heat dissipation plate separated by a semiconductor layer, and a heat sink abutting said heat dissipation plate.

In one embodiment, the heat absorption plate is arranged in thermal contact with said thermal transfer conduit.

In one embodiment, the active heat transfer device further comprises a fan arranged proximate any one or both of said heat dissipation plate and said heat sink to facilitate heat dissipation.

In one embodiment, the fan is located at a distance from said tunable refractive optical element.

In one embodiment, the thermal regulation system further comprises a temperature sensor configured to measure any one or both of a current operating temperature of said tunable refractive optical element and a casing temperature proximate said tunable refractive optical element.

In one embodiment, the thermal regulation system further comprises a control unit operable to activate and/or deactivate said thermal regulation system to maintain said current operating temperature of said tunable refractive optical element within said designated thermal operating range.

In one embodiment, the casing defines an optical channel comprising a viewing channel to an active digital display, wherein hardware associated with said active digital display produces heat within said casing, and wherein said use of said thermal regulation system at least partly compensates for operational heat generation.

In one embodiment, the optical system comprises a light field refractor.

In accordance with another aspect, there is provided a non-transitory computer-readable medium having computer-executable instructions stored thereon to modulate a thermal regulation system of an optical system, whereby the instructions, upon implementation by a digital data processor, selectively activate an active heat transfer device to transfer heat from a tunable optical refraction element mounted within a casing of the optical system to a thermally conductive element arranged in thermal contact therewith, to a thermal transfer conduit in thermal coupling therewith, to said active heat transfer device, so as to maintain favourable operation of said tunable refractive optical element within a designated thermal operating range.

In one embodiment, the active heat transfer device comprises a thermoelectric Peltier cooling device having a heat absorption plate and a heat dissipation plate separated by a semiconductor layer, and a heat sink abutting said heat dissipation plate, and wherein said selectively activating said thermoelectric Peltier cooling device comprises instructions to close an electric path through which electric current flows to said thermoelectric Peltier cooling device.

In one embodiment, the instructions further comprise instructions which, upon implementation by said digital data processor, receive from a temperature sensor within said casing a sensed operational temperature comprising any one or both of: a current operating temperature of said tunable refractive optical element and a casing temperature proximate said tunable refractive optical element.

In one embodiment, the instructions further comprise instructions which, upon implementation by said digital data processor, activate and/or deactivate said active heat transfer device based on said sensed operational temperature to maintain said tunable refractive optical element within said designated thermal operating range.

In one embodiment, the instructions further comprise instructions which, upon implementation by said digital data processor, activate and/or deactivate said active heat transfer device based on a predefined thermal cycle to maintain said tunable refractive optical element within said designated thermal operating range.

In one embodiment, the casing defines an optical channel therethrough and wherein said instructions further comprise instructions which, upon implementation by said digital data processor, applies a tunable refraction along said optical channel.

In one embodiment, the optical system comprises a light field refractor.

In one embodiment, the thermally conductive element is dimensioned to at least partially circumscribe said tunable refractive optical element in thermal coupling therewith.

Other aspects, features and/or advantages will become more apparent upon reading of the following non-restrictive description of specific embodiments thereof, given by way of example only, with reference to the accompanying drawings.

### BRIEF DESCRIPTION OF THE FIGURES

Several embodiments of the present disclosure will be provided, by way of examples only, with reference to the appended drawings, wherein:

FIG. 1 is a first front side perspective view of an optical system, in accordance with one embodiment;

FIG. 2 is a second front side perspective view of the optical system shown in FIG. 1;

FIG. 3 is a flow-diagram of the componentry of the optical system shown in FIGS. 1 and 2, illustrating thermal flow paths, in accordance with one embodiment;

FIG. 4 is a flow-diagram of the operation of the optical system shown in FIGS. 1 and 2, illustrating both activation and deactivation signal pathways of the exemplary thermal regulation system, in accordance with one embodiment; and

FIG. 5 is a flow-diagram of a method of thermally regulating an optical system having a casing and a tunable refractive optical element that is favourably operable within a designated thermal operating range, in accordance with one embodiment.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this invention belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references unless the context clearly dictates otherwise. The meaning of “in” includes “in” and “on” unless the context clearly dictates otherwise.

The term “comprising” as used herein will be understood to mean that the list following is non-exhaustive and may or may not include any other additional suitable items, for example one or more further feature(s), component(s) and/or element(s), as appropriate.

In this specification, the term “refractive optical element” may be used to refer to one or more optical elements disposed along an optical path and/or within an optical channel to refract light channeled therethrough in accordance with a designated optical purpose or application. For instance, a refractive optical element may be used to adjust a focus, collimate, redirect, or otherwise optically manipulate input light to produce a desired optical effect. In some embodiments, a “tunable” refractive optical element is disclosed in which an optical property of the element, notably a refractive power or effect of the element, can be dynamically adjusted to provide a dynamically or selectively variable refractive optical effect. In some particular embodiments, a refractive optical element will comprise a lens, such as a tunable lens, which may refer to a single lens or two or more lenses, in different embodiments and depending largely on the optical system application, although not limited thereto. In some embodiments, as the context will indicate, the term “lens” may refer to a plurality of lenses arranged or otherwise combined to provide a resulting compound optical effect along an optical path or within a single optical channel. In other embodiments, as the context will indicate, the term “lens” may refer to a plurality of lenses arranged or disposed in an array within a single optical channel. Furthermore, a lens may also or alternatively refer to a lens system or the like in which a complex or multiple optical paths and/or channels are deployed and in which a same or respective lenses are employed.

In this specification, it is to be appreciated the term “heat” may be used interchangeably with the term “energy” and vice versa, as the context may indicate and as will be readily appreciated by skilled artisans, without limitation.

In this specification, the term “favourable” generally refers to a temperature (and/or other operating parameters, as the context may indicate) at which the component, device, subsystem or system referred to may be favourably or ideally operable. In most embodiments, such favourable operation typically refers to at least a relatively predictable or stable level of accuracy, although not necessarily the most optimal operational accuracy. To provide one non-limiting example, if an optical component is considered operational between 15° C. and 25° C., and optimally operational at 20° C., a favourable operational range may be considered as between 18° C. and 22° C. Put differently, the favourable operational range may be considered the tolerable operational range within which a predefined level of accuracy is still achieved or obtained, or expected to be so achieved or obtained. Indeed, the determination of the favourable operational range need not be dependent in any manner, on the optimal operational temperature, although this provides one example.

In this specification, the term “approximate” or “approximately”, especially as used in the context of temperature, is generally used to refer to a temperature differential of 2.5 degrees above or 2.5 degrees below the stated temperature or temperature range. It is to be appreciated, nonetheless, that the temperature tolerance of different components, devices, subsystems and systems is variable, and as such, the meaning of the term “approximate” or “approximately” may be variable accordingly, without limitation, depending on the sensitivity, precision, tolerance and/or other such operating parameters of the device in question, in which a tighter or looser tolerance may be required or preferred.

In this specification, the terms “thermal contact” and “thermal coupling” are used interchangeably, also both interchangeable with the term “thermal interface” or the like, by which it is to be appreciated that physical contact or coupling is not requisite but may be employed in certain embodiments. The same applies to derivations of these terms.

The systems and methods described herein provide, in accordance with different embodiments, various mechanisms of thermally regulating an optical system, or components or subsystems thereof. Such thermal regulation may involve cooling and/or warming of the optical system in different embodiments. In some embodiments, such thermal regulation may be useful or necessary to maintain or at least attempt to maintain an operating temperature of one or more components of the optical system within a designated thermal operating range. Indeed, it is to be appreciated that some optical components have a designated thermal operating range which is necessary for operation, and additionally or alternatively, a designated thermal operating range which is favourable for operation. The systems and methods described herein are envisaged to achieve or maintain (at least partly) any one or both of such necessary and/or favourable operating temperature ranges in optical systems.

In some embodiments, the systems and methods described herein provide for the cooling of optical systems, particularly where hardware associated with the optical system (or a subsystem or component thereof) is known to produce operational heat in use. Such embodiments may have particular application where the optical system or the heat generating hardware thereof is encased or otherwise enclosed within a predefined volume, such that environmental heat dissipation is hindered or impeded by such encasing.

In some embodiments, the systems and methods described herein provide for the thermal regulation of optical systems using a selectively activatable heat transfer device which may ensure, for example, that the running of the thermal regulation system is limited to when necessary, in response to one or more operational parameters or otherwise based on thermal cycling. In embodiments where the systems and methods are implemented for cooling, such selective activation may further be beneficial where heat or warmth is generated during operation of the optical system, such that selective activation for cooling can be intermittent with periods of inherent (or operational) warming.

In some embodiments, the systems and methods described herein provide for the thermal regulation of optical systems using thermal transfer chains comprised predominantly of hardware, thereby relying (at least partly) on thermal conductive properties of one or more materials and providing a relatively robust thermal regulation system. In some embodiments, the thermal regulation system may be sufficiently robust to withstand vibration, rotation or other movement associated with operation of the optical system or other systems associated therewith. In some embodiments, the thermal regulation system may provide thermal transfer away from one or more components even without activation, by way of the thermal conductive properties of the materials employed. In some embodiments, thermal transfer is in part enabled or increased by a thermoelectric cooling device, whereby electrical signals can control the operation of the thermal regulation system in response to, for example, sensed operational temperatures over time, or otherwise in accordance with thermal cycling.

In some particular embodiments, the systems and methods described herein provide for the cooling of optical systems so as to favourably maintain a tunable refractive optical element within a designated thermal operating range. For such embodiments, it is to be appreciated that the tunable refractive optical element may itself generate, or otherwise the componentry associated with such tuning may generate, operational heat (along with other componentry associated with optical system displays or the like). In turn, heat generation may increase the current operational temperature of the tunable refractive optical element, thereby affecting or otherwise altering the refractive capabilities or performance of the tunable refractive optical element. Notably, temperature instability may lead to inaccurate or unpredictable operation or performance of the tunable refractive optical element. Temperatures above the designated thermal operating range may lead to failure of the tunable refractive optical element. In such embodiments, thermal regulation of the tunable refractive optical element may be directly or indirectly associated with the refractive capabilities or performance of the tunable refractive optical element and/or optical system. Accordingly, in some of these embodiments, the systems and methods described herein may specifically counteract heat generation from one or more components of the optical system, and particularly when impacting the tunable refractive optical element, so as to avoid heat interference and/or to provide as least predictable and ideally, accurate, operation of the tunable refractive optical element.

In some of these particular embodiments, the systems and methods described herein may specifically accommodate or account for vibration or other movement associated with moving components of the thermal regulation system (for example, a fan), so as to ensure that operation of the thermal regulation system or any component thereof does not interfere with the operation (or favourable operation) of the tunable refractive optical element or the componentry associated with such tuning.

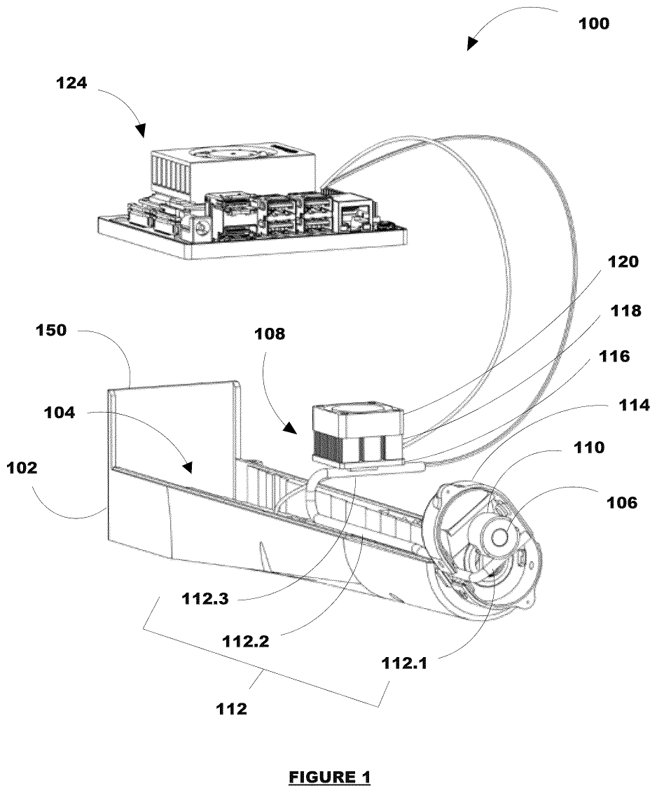

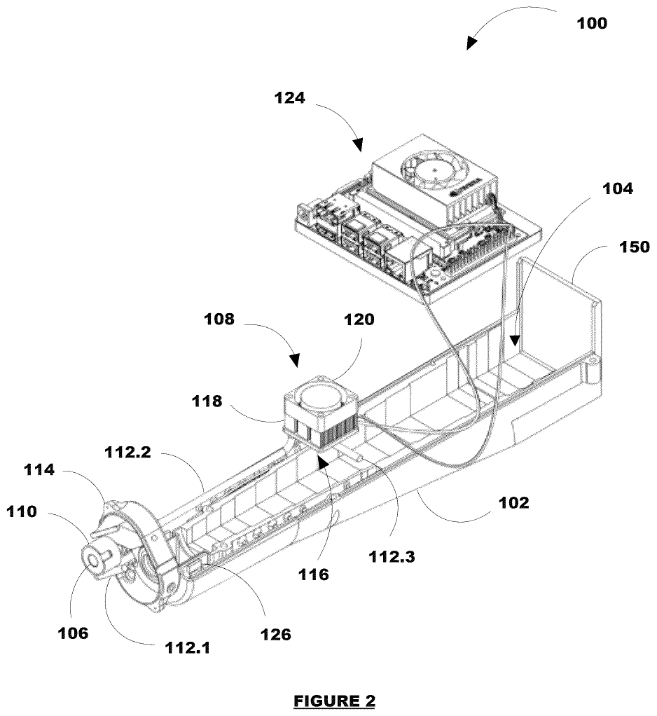

With reference to FIGS. 1 and 2, and in accordance with one exemplary embodiment, an optical system, generally referred to using the numeral 100, will now be described to provide one non-limiting example.

In this embodiment, the optical system 100 comprises a casing 102 defining an optical channel 104 therethrough, and a tunable refractive optical element 106 mounted within the casing 102 to apply a tunable refraction along the optical channel 104. The tunable refractive optical element 106 is favourably operable within a designated thermal operating range (or “designated favourable thermal operating range”). The optical system 100 further comprises a thermal regulation system, which in this embodiment comprises an active heat transfer device 108, a thermally conductive element 110 dimensioned to at least partially circumscribe the tunable refractive optical element 106 in thermal coupling therewith, and a thermal transfer conduit 112 thermally coupled between the active heat transfer device 108 and the thermally conductive element 110. In this embodiment, the active heat transfer device 108 of the thermal regulation system is activated or activatable to selectively transfer heat from the tunable optical refraction element 106 via the thermally conductive element 110 and the thermal transfer conduit 112 to the active heat transfer device 108 so as to maintain favourable operation of the tunable refractive optical element 106 within the designated thermal operating range.

In this particular embodiment, although not specifically shown in FIGS. 1 and 2, it is to be appreciated that the casing 102 (or housing) is in fact enclosed or encased around the optical channel 104, specifically defining an encased volume comprising the optical channel 104. Indeed, the casing 102 may further include an upper casing portion (or lid) which fits or attaches to the lower casing portion shown, to define the encased volume. As such, in this embodiment, operational heat generated by any componentry of the optical system 100, as described further below, is at least partly retained or trapped in the casing 102. Put differently, heat dissipation to the environment surrounding the optical system 100 is at least partly hindered or impeded by the casing 102. Accordingly, it is to be appreciated that over time, the casing 102 may cause retention of heat within the optical system 100, leading to a temperature rise inside the casing 102 and/or of componentry of the optical system 100, including specifically the tunable refractive optical element 106.

In this embodiment, the active heat transfer device 108 is located within the casing 102 at a distance from the tunable refractive optical element 106, as shown in FIG. 2. In this embodiment, distancing the active heat transfer device 108 from the active heat transfer device 108 at least partly ensures that the operation of the tunable refractive optical element 106, during refractive tuning or the like, is not impacted or affected by vibrations exerted by the active heat transfer device 108 (or a component thereof), heat emitted by the active heat transfer device 108 (or a component thereof) or the like, to provide some non-limiting examples. Although not specifically shown, it is to be appreciated that the active heat transfer device 108 in this embodiment is located within upper portion of the casing 102.

In this embodiment, the tunable refractive optical element 106 is substantially cylindrically shaped and dimensioned and the thermally conductive element 110 is complementarily shaped and dimensioned to at least partially circumscribe or put differently, at least partially wrap around, same. In particular, in this embodiment, the thermally conductive element 110 fully circumscribes the tunable refractive optical element 106. More specifically, in this embodiment, the thermally conductive element 110 is a substantially ring-shaped member, as shown in FIGS. 1 and 2. Notably, in this embodiment, it is of importance that the thermally conductive element 110 does not obstruct or otherwise constrict the operation and/or refractive capability of the tunable refractive optical element 106, whilst still making thermal contact therewith for the purposes of heat transfer.

In this embodiment, the thermally conductive element 110 is manufactured of a material having high thermal conductivity. More particularly, the thermally conductive element 110 in this embodiment is manufactured of a metal and specifically, copper, though other thermally conductive materials may be readily employed (e.g. aluminum). Manufacturing the thermally conductive element 110 of a high thermal conductivity material, such as copper, may facilitate heat transfer from the tunable refractive optical element 106 to the thermally conductive element 110 (and in turn, to the rest of the thermal regulation system). Selection of the thermally conductive material may be impacted by other operational characteristics of the device (e.g. operating frequencies or tolerances of other device componentry) and/or material shaping, forming and/or manufacturing characteristics that may affect one's ability to produce and/or couple thermally conductive components of the herein described embodiments within a given configuration or arrangement. For example, electromagnetic properties of a given thermally conductive material may be selected to minimize other operational artefacts, such as electromagnetic interference in high frequency devices, or the like, that may vary from one material to the other depending on such operational characteristics.

In this embodiment, as shown in FIGS. 1 and 2, the copper ring 110 snugly fits around the tunable refractive optical element 106. More specifically, in this embodiment the copper ring 110 is friction-fit around the tunable refractive optical element 106, whereby the thermal contact between these components is also physical contact. For instance, the copper ring 110 can be pressure fit or otherwise mounted in thermal contact with the shell or body of the tunable lens, in this case a pair of tunable lenses, for effective heat dissipation and/or temperature control. In this particular embodiment, the copper ring 110 has an inner diameter of 16.15 mm and an outer diameter of 18.15 mm.

In this embodiment, the thermal transfer conduit 112 comprises a thermally conductive pipe. More specifically, in this embodiment, the thermally conductive pipe 112 is made up of three thermally conductive pipe portions 112.1, 112.2, 112.3 which are arranged in thermal contact with one another, in one embodiment formed from a single metallic pipe bent and shaped for purpose, forming a thermal transfer chain from the thermally conductive element 110 to the active heat transfer device 108 (or a component thereof). As shown in FIG. 1, a first thermally conductive pipe portion 112.1 is in thermal contact with the copper ring 110 on one end, and specifically in this embodiment, is in physical contact therewith, so as to facilitate the transfer of heat from the copper ring 110 thereto. In this particular embodiment, the first thermally conductive pipe portion 112.1 is arranged across the width of the optical channel 104 (or generally perpendicular thereto), beneath the copper ring 110. In this embodiment, a second thermally conductive pipe portion 112.2 integrally extends from or is in thermal contact with the first thermally conductive pipe portion 112.1 so as to facilitate the transfer of heat from the first thermally conductive pipe portion 112.1 thereto and therethrough. In this embodiment, the second thermally conductive pipe portion 112.2 is arranged within the casing 102, specifically along the length of the optical channel 104 (or generally parallel thereto). In this embodiment, a third thermally conductive pipe portion 112.3 integrally extends from is in thermal contact with the second thermally conductive pipe portion 112.2 so as to facilitate the transfer of heat from the second thermally conductive pipe portion 112.2 thereto and therethrough. In this embodiment, the third thermally conductive pipe portion 112.3 is arranged within the casing 102, specifically across the width thereof (or generally perpendicular thereto) and above the optical channel 104. Accordingly, none of thermally conductive pipe portions 112.1, 112.2, 112.3 obstruct the optical channel 104. As will be appreciated by the skilled artisan, the shaping and disposition of the pipe 112 as illustrated in this embodiment is specific to the geometrical arrangement thereof, and may vary for other embodiments that may include alternate optical configurations or dispositions. Also, while a unitary heat transfer pipe is illustrated herein, other assembled heat transfer configurations may alternatively be considered. In this particular embodiment, a carefully bent and shaped heat pipe was selected to improve heat transfer capabilities.

In this embodiment, at least a portion of the conductive pipe includes a substantially right-angled bend of bend radius sufficiently large so to not adversely impact heat transfer, while at least one portion the conductive pipe traverses through an optical element support frame 114 (notably, this optical element support frame 114 may be operable, amongst other functions, to support the tunable refractive optical element 106 within the optical channel 104 and/or to support the first thermally conductive pipe 112.1 portion in thermal contact with the copper ring 110).

In this embodiment, the thermally conductive pipe 112 is manufactured of a material having high thermal conductivity. More particularly, the thermally conductive pipe 112 in this embodiment is manufactured of a metal and specifically, copper. Manufacturing the thermally conductive pipe 112 of a high thermal conductivity material, such as copper, may facilitate heat transfer from the thermally conductive element 110 to the thermal transfer chain (and in turn, to the active heat transfer device 108).

In this embodiment, the thermally conductive pipe 112 and the conductive connecting members forming the thermal transfer chain, are specifically arranged so as to avoid obstruction of, interference with, or the like, of the optical channel 104 and/or the tunable refractive optical element 106.

In this embodiment, the active heat transfer device 108 comprises a thermoelectric cooling device. More specifically, the thermoelectric cooling device 108 in this embodiment comprises a Peltier device 116 having a heat absorption plate and a heat dissipation plate separated by a semiconductor layer (details not specifically shown). In this embodiment, the Peltier device 116 and/or its componentry is in the form of any conventional Peltier cooling device known in the art, having a generic construction such as that known to skilled artisans. This particular Peltier device 116 has the following specifications: 5.5 W at 27° C., 1.2 A 120° C. In this embodiment, notwithstanding the conventional structure of the Peltier device 116, selection of the shape and/or dimensions of the Peltier device 116 is characterized by ensuring that the Peltier device 116 does not, at least in any substantial manner, obstruct or block the optical channel 104 (or, as described below, the viewing channel). Additionally, or alternatively, selection of the shape and/or dimensions of the Peltier device 116 is characterized by ensuring that the Peltier device 116 does not, at least in any substantial manner, obstruct or block any other applicable componentry of the optical system 100, including the driver board 126. In this embodiment, selection of the Peltier device 116 is further characterized by ensuring that the Peltier device 116 has a minimum surface area to suit or account for an outer perimeter of the tunable refractive optical element 106 (being the object which is to be ultimately cooled in this embodiment) to ensure sufficient heat transfer capabilities. In other embodiments, other selection criteria for the Peltier device 116 may be considered or preferred.

It should be appreciated that, in the embodiment shown in FIGS. 1 and 2, the Peltier device 116 is arranged such that, from the bottom of the respective drawings upwards, the heat absorption plate is in thermal contact with the third thermally conductive pipe portion 112.3, so as to absorb or draw heat therefrom in use, the semiconductor layer is between the heat absorption plate and the heat dissipation plate, and the heat dissipation plate is in thermal contact with a heat sink 118 (described further later). As such, based on the foregoing, the heat absorption plate is arranged in thermal contact with thermal transfer conduit portion 112.3. It should be further appreciated that the Peltier device 116 is typically in an inactive state when no electric current is supplied thereto (although some thermal transfer may occur due to the inherent thermal conductivity of the materials used), but is selectively activated by supplying current thereto, as with any conventional Peltier device.

In this embodiment, the active heat transfer device 108 further comprises a fan 120 arranged proximate the heat dissipation plate of the Peltier device 116 to facilitate heat dissipation to the environment surrounding the optical system 100. In this embodiment, wherein the active heat transfer device 108 comprises a heat sink 118, this heat sink 118 is arranged between the heat dissipation plate and the fan 120, specifically abutting the heat dissipation plate. In this embodiment, the heat sink 118 and/or its componentry is in the form of any conventional heat sink known in the art, having a generic construction such as that known to skilled artisans. In one non-limiting example, the heat sink 118 has the following dimensions: 30×30×12.7 mm and has the a thermal resistance (R) of 2.45° C./W. The heat sink 118 is operable, in this embodiment, to increase heat transfer away from the heat dissipation plate of the Peltier device 116 when in use. The fan 120 and/or its componentry is also in the form of any conventional electric fan known in the art, having a generic construction such as that known to skilled artisans. In this particular embodiment, the fan 120 comprises a direct current (DC) fan. In this embodiment, the heat sink 118 and the fan 120 are similarly matched in terms of footprint (i.e. length and width) so as to direct or blow air flow over the at least most of the surface area the heat sink 118. In particular, in this embodiment, the Peltier device 116 is 14.2 mm long by 11.2 mm wide, and the fan 120 has a similar footprint. In this embodiment, although not specifically shown, the fan 120 is arranged with reference to the casing 102 so as to exhaust warm (or heated) air to the environment surrounding the casing 102 and/or the optical system 100.

In this embodiment, the fan 120 is specifically located at a distance from the tunable refractive optical element 106. As will be appreciated by skilled artisans, the fan 120 in operation produces certain rotational and/or vibrational movements which may, as so in this embodiment, potentially interfere with or otherwise impact the operation and/or accuracy of the tunable refractive optical element 106. Accordingly, in this embodiment, as shown in in FIG. 2, the fan 120 (together with other components of the active heat transfer device 108 in this embodiment) is spaced away from the tunable refractive optical element 106. Specifically, whilst the fan 120 is positioned within the casing 102, it is installed or attached at a position relatively upwards in the optical channel 104 in this embodiment. In some embodiments, the distance suitable for separation between the tunable refractive optical element 106 and the fan 120 may be tested for a particular optical system application. Notably, in addition or in alternative to the foregoing benefit of avoiding vibrational interference, distancing the fan 120 from the tunable refractive optical element 106 may present one or more other benefits, including but not limited to: ensuring airflow does not enter the optical channel 104 or otherwise interfere with the tunable refractive optical element 106; ensuring that there is no pressure build-up or other pressure differential associated with the fan 120 or the optical channel 104; and ensuring that no dust, debris or the like is directed into the optical channel 104 or close to the tunable refractive optical element 106.

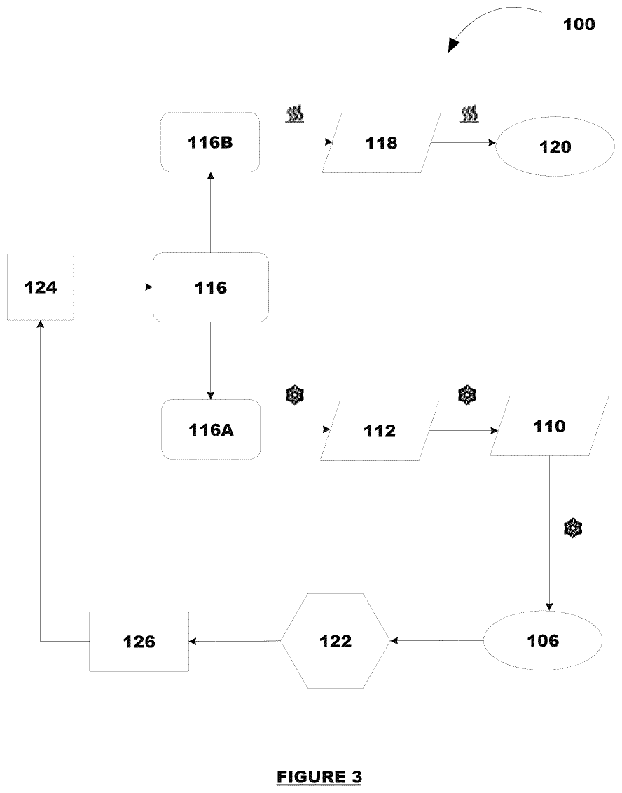

In this embodiment, although not specifically shown, the thermal regulation system further comprises a temperature sensor 122 (only shown in FIG. 3). In this embodiment, the temperature sensor 122 is configured to measure a current operating temperature of the tunable refractive optical element 106. In this embodiment, the temperature sensor 122 is arranged proximate to the tunable refractive optical element 106, specifically on a lower side of the optical element support frame 114 and within the lens assembly casing (not specifically shown), so as to detect thermal (i.e. electrical) signals from or in the vicinity of the tunable refractive optical element 106 during operation of the optical system 100. The temperature sensor 122 may comprise a thermistor, a thermometer or the like, or any conventional temperature sensor known to skilled artisans.

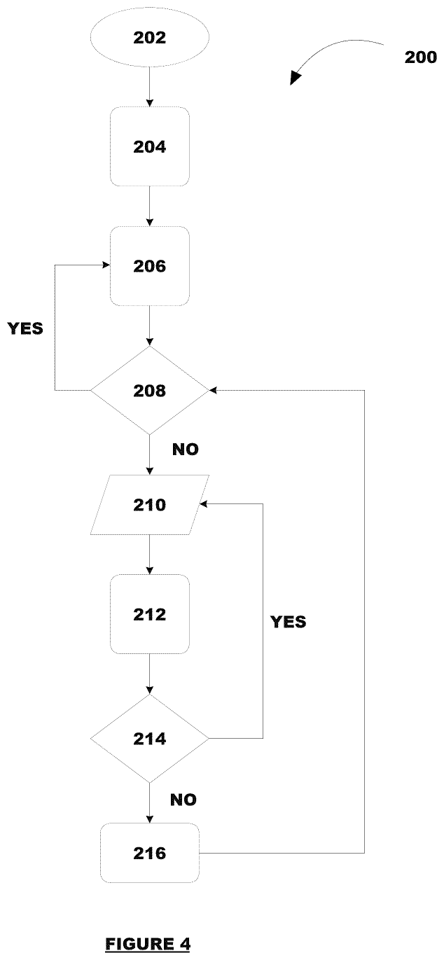

In this embodiment, as briefly mentioned, the optical system 100 further comprises a control unit 124 (shown in FIGS. 1 to 3) which is operable to activate and/or deactivate the thermal regulation system to maintain a current operating temperature of the tunable refractive optical element 106 within the designated thermal operating range. Indeed, in this embodiment, the control unit 124 comprises an embedded system having a combination of a computer processor (or microcontroller), computer memory and input/output peripheral devices that contribute to this function. In this particular embodiment, the control unit 124 is operable to activate or deactivate the thermal regulation system based, at least in part, on a sensed operational temperature received from the temperature sensor 122. As noted above, in this embodiment, the sensed operational temperature comprises a current operating temperature of the tunable refractive optical element 106. Activation and/or deactivation signals from the control unit 124 in this embodiment, result in current flow changes to the active heat transfer device 108 (i.e. Peltier device 116 and fan 120). Further details of the operation of this control unit 124 are provided below, with reference to FIG. 4.

In this particular embodiment, as noted, the embedded control unit 124 comprises a computer processor (or microcontroller) for autonomous machines, in an embedded module. For example, the control unit 124 may be in the form of NVIDIA® Jetson™ Xavier NX. Notably, other embodiments may employ other computing or processing units, without limitation.

In this embodiment, the optics system 100 further comprises a driver board 126, which may be considered part of the control unit 124 in other embodiments but which, in this embodiment, is a separate component therefrom (shown in FIG. 2). The driver board 126 in this embodiment comprises the circuitry to convert an analog signal from the temperature sensor 122 to a digital signal, for further processing by the control unit 124.

In this embodiment, the optics system 100 further comprises a power source (not shown) for providing current to any one or combination of the temperature sensor 122, control unit 124, driver board 126 and active heat transfer device 108 (or specific component(s) thereof). In this embodiment, the power source comprises the power supply to the tunable refractive optical element 106 and/or the actuation componentry thereof.

In this embodiment, the tunable refractive optical element 106 comprises a tunable lens. More specifically, the tunable lens 106 comprises a tunable liquid lens. The tunable liquid lens is a focus tunable lens, which has a changeable or adjustable shape based on a combination of optical fluids and a polymer membrane, as will be understood by skilled artisans, thereby to adjust refractive capability of the lens 106. In this embodiment, the tunable liquid lens 106 is electrically activated, specifically by means of electrowetting. Examples of exemplary tunable liquid lenses 106 which are commercially available and which may be employed in this embodiment include Corning® Varioptic® lenses and Optotune™0 EL lenses, although the optics system 100 and indeed, the thermal regulation system herein disclosed, may be workable with various other lenses and lens types, as later described, as well as various other optical systems.

In this embodiment, the designated thermal operating range of the tunable liquid lens 106 is approximately 17° C. to 23° C. Notably, in this embodiment, the designated thermal operating range is designated or predefined based on a knowledge of the optical system 100 and/or testing of same for favourable operational parameters, including temperature. Accordingly, as noted elsewhere, the designated thermal operating range will understandably differ between different optical systems and/or componentry used (hardware and/or software). Where the designated thermal operating range is unknown, testing of the optical system 100 before configuration of the thermal regulation system may be prudent. Returning to the instant embodiment, whilst the designated thermal operating range of the tunable liquid lens 106 is approximately 17° C. to 23° C., within which range the refractive capability of the tunable liquid lens 106 is at least predictable, it is further known that lens temperatures in the order of 26° C. or 27° C. may begin affecting the predictability and/or accuracy of the tunable liquid lens 106.

In this embodiment, the optical channel 104 comprises a viewing channel to an active digital display 150. In this embodiment, the tunable liquid lens 106 variably refracts pixelated content projected by the active digital display 150. This variable refraction of the pixelated content on the active digital display 150 is operable, in this embodiment, to test the visual acuity of a patient. Indeed, in this particular embodiment, the optical system 100 specifically comprises a light field refractor (having a digital display 150 and a microlens array disposed at a distance therefrom (not shown)) for this purpose. The light field refractor 100 may be a diagnostic or screening device, for diagnosing optical conditions, aberrations or the like, determining prescriptions for same, or the like. Other vision-based testing capabilities, such as for screening or testing for cognitive impairments such as a concussion or the like, may also be applied. Indeed, as will be understood by skilled artisans, light field refractors 100 are known to adjust a user's perception of an input image by adjusting a light field emanated by the active digital display 150 so to control how a light field image is ultimately projected for viewing. For instance, in some examples related to determining prescriptions, users who would otherwise require corrective eyewear, may consume images produced by such light field refractors in clear or improved focus without the use of such corrective eyewear. Although the present disclosure is not limited in application to the thermal regulation of tunable optical elements (such as tunable liquid lenses) forming part of light field refractors, this use case has been specifically implemented, in accordance with one embodiment, with usage of at least one of the embodiments disclosed in U.S. patent application Ser. No. 17/957,845 filed on Sep. 30, 2022, the entire disclosure of which is incorporated herein by reference.

Notably, the thermal regulation system of this embodiment at least partly compensates for operational heat generation. In this embodiment, the hardware associated with the active digital display 150 produces heat within the (enclosed) casing 102 which can be addressed and lowered over time with the thermal regulation system. Additionally, or alternatively, the hardware associated with actuating the tunable liquid lens 106 and indeed, the actuation of the tunable liquid lens 106 itself, generates heat within the casing 102 which can be addressed and lowered over time with the thermal regulation system.

FIG. 3 provides a flow-diagram of the hardware components of the optical system 100 and the thermal flow paths therebetween, to further illustrate the relationship between the componentry of this embodiment of the optical system 100 when in operation, particularly with reference to the thermal regulation system and how heat generated is extracted from the system 100 to cool the tunable optical refractive element 106 to within the designated (favourable) thermal operating range.

As shown in FIG. 3, the tunable optical refractive element 106 (specifically, the tunable liquid lens in this embodiment), is monitored by temperature sensor 122. Notably, the temperature sensor 122 provides real-time lens temperature monitoring in this embodiment, as it is built into the assembly surrounding the tunable liquid lens 106. In this embodiment, the sensed operational temperature is measured by temperature sensor 122 in analog format. The analog sensed operational temperature is then sent to the driver board 126 for conversion to digital signal. From the driver board 126, the digital signal is sent to the control unit 124 for processing. The control unit 124 determines whether the sensed operational temperature (specifically, the average sensed temperature over a predefined interval) is within the designated thermal operating range. If the sensed operational temperature is not within the designated thermal operating range, or again closely approaches an out of range value, the control unit 124 sends an activation signal (or command) to the Peltier device 116, which activates the Peltier device 116 circuitry to supply electrical current thereto (note, although not specifically shown in FIG. 3, the activation signal may also be relayed to the fan 120, as described later with reference to FIG. 4). Once activated, current moving through the Peltier device 116 means that heat is transferred from the heat absorption plate 116A (or cold surface of the Peltier device), across the semiconductor layer, to the heat dissipation plate 116B (or hot surface of Peltier device), thereby continuously cooling the heat absorption plate 116A (to absorb more heat) and continuously warming the heat dissipation plate 116B (to dissipate more heat). From the heat dissipation plate 116B, heat approximately in the range of 32° C. to 40° C., is transferred to the heat sink 118. From the heat sink 118, this heat is exhausted by means of the fan 120. The heat absorption plate 116A on the other hand, which is cooled from approximately 19° C. to approximately 12° C., draws or transfers heat from the thermal transfer conduit 112 (or heat pipe), which in turn, draws or transfers heat from the thermally conductive element 110 (or copper ring), which in turn, draws or transfers heat from the tunable optical refractive element 106 (or tunable liquid lens), thereby cooling the latter during operation. In particular, in this embodiment, the overall cooling of the tunable optical refractive element 106 is approximately 13° C. after 2 hours of continuous operation of the optical system 100. FIG. 3 thus broadly shows two heat transfer pathways, the first for cooling the optical refractive element 106 during operation (i.e. from 106 to 110 to 112 to 116A) and the second for releasing or exhausting the heat from the Peltier device 116 (i.e. from 116B to 118 to 120). FIG. 3 does not show the deactivation signal pathway, which will be explained further with reference to FIG. 4.

Further use of the thermal regulation system will now be discussed with reference to FIG. 4. FIG. 4 provides one exemplary embodiment of how the optics system 100, including the thermal regulation system, may be utilized to maintain the tunable refractive optical element 106 within the designated thermal operating range, particularly by means of two separate but complementary activation and deactivation signal pathways. As such, one specific embodiment of a method 200 of operating system 100 to thermally regulate optical system 100 is considered disclosed. Although reference will be made to certain components of the embodiment of optical system 100 described above (e.g. the tunable refractive optical element 106 being a tunable liquid element), it is to be appreciated that the principles described may be equally applicable to other envisaged embodiments of the system which fall within the scope of the present disclosure.

In FIG. 4, the method 200 commences at 202, where the optical system 100 is started or operation is commenced. Since the hardware associated with the optical system 100 (for example, the active digital display 150 and/or lens actuation componentry) generates heat during operation, it is to be appreciated that the overall temperature within the casing 102 will (sometimes gradually, sometimes near immediately) increase after starting the optical system 100. At 204, the temperature sensor 122 determines in real-time the sensed operational temperature of the tunable liquid element 106 and, after signal conversion by the driver board 126, the control unit 124 stores the sensed operational temperature in a log file (in effect, forming temperature data) in connection with the control unit 124. Notably, this storing 204 of sensed operational temperature is, in this embodiment, an ongoing step for as long as the optical system 100 is operational (and optionally, for a predetermined period thereafter), to maintain the temperature of the tunable refractive optical element 106 within the designated thermal operating range in use, for favourable operation. At 206, the control unit 124 calculates an average temperature from the temperature data stored. This average temperature may be an average based on sensed operational temperatures stored since the optical system 100 was started for a particular session, or otherwise an average over a predefined time period (such as, over one minute). At 208, the control unit 124 determines whether the average temperature is low enough to be within the designated thermal operating range. As such, the control unit 124 compares the average temperature to the designated thermal operating range (which is predefined, as described above).

Continuing describing the method 200, at 208, if the average temperature is within the designated thermal operating range, else less than the lower limit of same, the control unit 124 follows the “YES” path and continues to calculate the average temperature at 206. If the average temperature is more than the designated thermal operating range (i.e. above the upper limit of the range), the control unit 124 follows the “NO” path and continues to 210 to activate or turn on the active heat transfer device 108 (including the fan 120 and/or the Peltier device 116). In particular, at 210 an activation signal is sent via the General Purpose Input/Output (GPIO) interface of the control unit 124 to a DC converter, which feeds both the fan 120, as well as to the Peltier device 116, in this embodiment. At 212, the DC converter is turned on or activated, thereby supplying electricity to the fan 120 and the Peltier device 116, and as such, selectively activating the active heat transfer device 108. Indeed, upon activation, current flows through the Peltier device 116, transferring heat from the heat absorption plate 116A to the heat dissipation plate 116B (this activation drawing or pulling heat from the rest of the thermal transfer chain and in turn, the tunable refractive optical element 106), the heat sink 118 draws or pulls heat from the heat dissipation plate 116B of the Peltier device 116 and the fan 120 blows cool air towards the heat dissipation plate 116B and/or extracts warm air from the heat dissipation plate 116B to expel same to the environment surrounding the casing 102.

At 214, when the active heat transfer device 108 is active, the control unit 124 determines, specifically from the average temperature (sensed and calculated), whether the average temperature is consequently low enough to be within the designated thermal operating range or whether it is still too high. As such, the control unit 124 again (and typically iteratively during operation of the optical system 100) compares the average temperature to the designated thermal operating range at 214. From 214, if the average temperature is still too high, being above the upper limit of the designated thermal operating range, the control unit 124 follows the “YES” path and returns to 210, thereby continuing or repeating the activation signal to the active heat transfer device 108 to continue active cooling of the optics system 100 and the tunable refractive optical element 106 in particular. If at 214, the average temperature is not still too high, but is instead within the designated thermal operating range, else less than the lower limit of same, the control unit 124 follows the “NO” path to 216 to deactivate or turn off the active heat transfer device 108 (including the fan 120 and/or the Peltier device 116). In particular, at 216 in this instance, a deactivation signal is sent via the GPIO interface of the control unit 124 to the DC converter. As such, at 216, the DC converter is turned off or deactivated, thereby ceasing or interrupting the supply of electricity to the fan 120 and the Peltier device 116, and thereby selectively deactivating the active heat transfer device 108. Indeed, without current flow, only minimal heat transfer may occur through the Peltier device 116 and the fan 120 will not operate. As shown in FIG. 4, once the active heat transfer device 108 is deactivated, the control unit 124 will continue to monitor the operating temperature of the tunable refractive optical element 106 by the feedback loop to 208, to maintain the favourable designated thermal operating range. Typically, method 200 will end once the optical system 100 is turned off or otherwise, after a predefined period thereafter.

It is to be appreciated that various alternative embodiments of the optical system 100 are envisaged, as well as various alternative embodiments of the thermal regulation system in particular, without departing from the general nature and scope of the instant disclosure. Some of these embodiments or variations are briefly described hereunder.

In other embodiments, the tunable refractive optical element 106 may have any shape and/or dimensions for the respective application of the optical system 100 and may, in some embodiments, include multiple or a plurality of tunable refractive optical elements arranged in parallel, in an array or the like, to achieve a desired function.

In some embodiments, the active heat transfer device 108 (or any components thereof, including the Peltier device 116 and/or fan 120) may be located external to the casing 102. In some embodiments, the active heat transfer device 108 may be located a distance closer to or further away from the tunable refractive optical element 106. Indeed, in some embodiments, the active heat transfer device 108 may be located in proximity to the tunable refractive optical element 106, particularly, for example, where the tunable refractive optical element 106 is sufficiently stable so as to not be affected by any vibrations, temperature or the like exerted by the active heat transfer device 108 in operation. In some embodiments, operation of the optics system 100 may be tested with placement of the active heat transfer device 108 relative to the tunable refractive optical element 106 differing, so as to identify at which distance from the tunable refractive optical element 106 the active heat transfer device 108 causes minimal impact or interference.

In other embodiments, the thermally conductive element 110 may have any shape and/or dimensions so as to complement the shape and/or dimension of the tunable refractive optical element 106, and specifically, to be in thermal contact therewith so as to draw heat therefrom. In some embodiments, the thermally conductive element 110 may comprise an arrangement of thermal conductor wiring arranged around the tunable refractive optical element 106, such as a helical thermally conductive element. In some embodiments, the thermally conductive element 110 may comprise a stacked arrangement of thermal conductor rings arranged in juxtaposition around the tunable refractive optical element 106.

In other embodiments, the thermal transfer conduit 112 may comprise any number of thermally conductive pipes (one or more), forming the thermal transfer chain from the thermally conductive element 110 to the active heat transfer device 108. Indeed, in such embodiments, any number of thermally conductive pipes 112 may be arranged in any manner or configuration, which may include locations outside of the casing 102 or the like. Furthermore, any number of thermally conductive pipes 112 may include bends or the like along its length, to accommodate or traverse through other componentry of the optical system 100, for example.

In other embodiments, the thermal transfer conduit 112 may be arranged along the optical channel 104 of the casing 102 in any manner or configuration so as not to obstruct or interfere with the optical channel 104 and/or the tunable refractive optical element 106 (and/or any other applicable componentry of optical system 100). In yet other embodiments, the thermal transfer conduit 112 may be arranged external to the casing 102, thereby facilitating heat transfer to the environment (air) prior to reaching the active heat transfer device 108. In some embodiments, the thermal transfer conduit 112 may be attached or otherwise encased in an external channel attached to an external wall of the casing 102 to avoid damage and/or breakage in use.

In other embodiments, the thermal transfer conduit(s) 112 may be manufactured of any material having high thermal conductivity, and in yet others, the thermal transfer conduit(s) 112 may be manufactured of high thermal conductivity material encased in a low thermal conductivity material (or insulator). In such embodiments, encasing the thermal transfer conduit(s) 112 may be beneficial to ensure, for example, that the casing 102 is not continuously heated by the transfer of heat along the thermal transfer chain.

In other embodiments, the thermal transfer conduit 112 may comprise a rod or the like, which allows the transfer of heat from the thermally conductive element 110 to the active heat transfer device 108. In other embodiments, the thermal transfer conduit 112 may comprise a fluid-circulating conduit. Such embodiments may be particularly useful where, for example, fluid circulating within the fluid-circulating conduit is used to cool the optics system 100 or any particular component thereof (for example, the tunable refractive optical element 106). Such embodiments may in addition or in the alternative thereto, form part of a larger liquid cooling device or system, as described elsewhere herein.

In some embodiments, particularly where the optical system 100 includes a camera, the selection of the shape and/or dimensions of the Peltier device 116 may be characterized by ensuring that the Peltier device 116 does not, at least in any substantial manner, obstruct or block the camera. In some embodiments, the selection of the Peltier device 116 may be further characterized by ensuring that the Peltier device 116 has a minimum surface area to suit or account for an external area (as opposed to periphery only) of the tunable refractive optical element 106 so as to ensure proper heat transfer.

In some embodiments, the active heat transfer device 108 may comprise a liquid cooling device. For example, in some embodiments, the active heat transfer device 108 may include a water block to transfer heat into a liquid and a heat exchanger with one or more fans to dissipate heat from the liquid in the heat exchanger to the environment (air). Such embodiments may include one or more pumps for moving the liquid around conduits, components and/or reservoirs forming part of the liquid cooling device, and indeed, the control unit 124 or similar may be operable to regulate fluid flow between the conduits, components and/or reservoirs to facilitate heat transfer. In some embodiments, the liquid may comprise a coolant. In some embodiments, the liquid cooling device may form a closed coolant recirculating system. In yet other embodiments, the liquid cooling device may be in the form of a refrigeration-type cooling system.

In some embodiments, the temperature sensor 122 may be configured to measure a casing temperature proximate the tunable refractive optical element 106 (as opposed to the current operating temperature of the tunable refractive optical element 106 itself), such that the control unit 124 can adjust the thermal regulation system accordingly. In some embodiments, the temperature sensor 122 may be configured to measure both of the current operating temperature of the tunable refractive optical element and the casing temperature proximate the tunable refractive optical element simultaneously, or otherwise two temperature sensors 122 may be operable to measure each respective temperature, and in such embodiments, the control unit 124 or other processor may be configured to adjust the thermal regulation system based on both such measured temperatures.

In some embodiments, the temperature sensor(s) 122 may be located beneath the thermally conductive element 110, or between the thermally conductive element 110 and the tunable refractive optical element 106. In other embodiments, the temperature sensor(s) 122 may be incorporated into the tunable refractive optical element 106 assembly itself. In yet other embodiments, the temperature sensor(s) 122 may be located proximate or distant from the tunable refractive optical element 106, within the casing 102.

In other embodiments, the control unit 124 may be operable to activate and/or deactivate the thermal regulation system (or, in some embodiments, activating the active heat transfer device 108) in accordance with a predefined thermal cycle. For example, the predefined thermal cycle may include activating the thermal regulation system (or active heat transfer device 108) for a 7-minute interval to cool the system 100 (particularly the tunable refractive optical element 106, after a period of operation), followed by 3-minute deactivation interval, which allows the operating temperature to increase to a predefined temperature before the system is activated again to cool it (and particularly the tunable refractive optical element 106). As such, in this example, these intervals may be iterated such that each 10 minutes, the predefined thermal cycle allows “natural” or “inherent” warming, and active cooling in response. In some embodiments, such a predefined thermal cycle may be based on the designated thermal operating range and any one or both of: an expected casing operational temperature range and an expected ambient temperature range. Indeed, the predefined thermal cycle may be determined beforehand based on expected operating and/or ambient temperatures, particularly where the componentry of the optics system 100 is known and where same is designed for use in room temperature environments, for example. In yet other embodiments, the predefined thermal cycle may be based alternatively or additionally on an expected lens operational temperature over time (i.e. an expected lens temperature profile during operation of the optics system 100).

In other embodiments, the control unit 124 may be operable to activate or deactivate the thermal regulation system based at least in part on the sensed operational temperature received from the temperature sensor 122. In different embodiments, the sensed operational temperature may comprise any one or both of a current operating temperature of the tunable refractive optical element 106 and a casing temperature proximate the tunable refractive optical element 106. Notably, in embodiments where casing temperatures are employed, such temperature readings may serve to infer or calculate therefrom the operating temperature of the tunable refractive optical element 106, so as to maintain the temperature thereof at the designated thermal operating range.

In some embodiments, the control unit 124 may include a memory, whether a permanent memory or a temporary memory, to support processing of temperatures sensed and/or activation and/or deactivation of the active thermal transfer device 108 over time.

In some embodiments, the driver board 126 may form part of the control unit 124. In other embodiments, the control unit 124 may be an existing part of the optical system 100 (for example, a control unit principally controlling refraction of the lens 106).

In other embodiments, the tunable lens may be in the form of any lens for which the focal length can be adjusted or varied as required. In other embodiments, the tunable lens may be manually tunable. In other embodiments, the tunable lens, whether electrically or manually actuated, may be a focus tunable lenses for any one of: machine vision, microscopy, endoscopy or the like, to name but a few non-limiting examples.

In other embodiments, the tunable liquid lens 106 may be manually actuated for tuning, or a combination of electrical and manual actuation. In embodiments making use of electrical actuation, other embodiments such as using liquid-crystal cells for actuation are intended to fall within the scope of the present disclosure. Indeed, the tunable liquid lens 106 may be actuated by or with the assistance of heat, sound or other techniques known in the art.

In other embodiments, the power source may comprise a mains power supply, a battery or the like, providing current to one or more components of optical system 100.

In some embodiments, the optical system 100 may form part of a monocular. In other embodiments, the optical system 100 may form part of a binocular, having similar optical systems 100 installed in each telescope to provide cooling to each telescope and/or lens as needed. For example, within the context of a refractor or phoropter-liked device, identical digital light field monocular devices may be disposed and operated side-by-side to provide for binocular vision-based testing capabilities. In such embodiments, distinct respective cooling subsystems may be deployed for each monocular, or a common or at least partially shared cooling subsystem may be deployed to address tunable refractive elements disposed in each monocular (e.g. a common Pelletier device, heat sink and fan operatively dissipating heat channeled thereto via respective heat transfer conduits in thermal contact with respective tunable refractive components).

In other embodiments, the optics system 100 may comprise any one or more of: a virtual reality headset (for example, the tunable refractive optical element being a Fresnel lens), or the like.

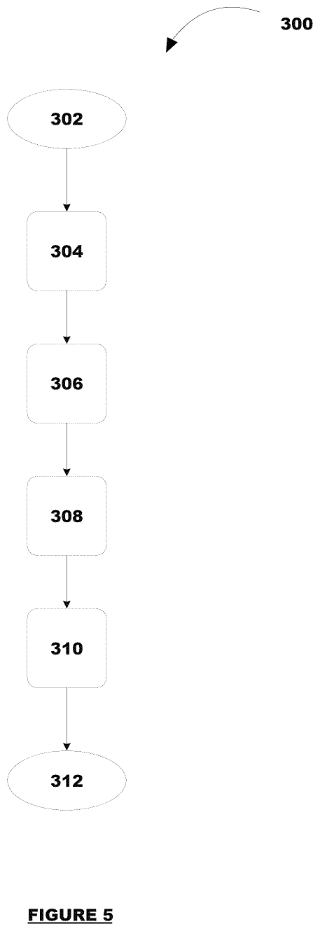

With reference to FIG. 5 and in accordance with another exemplary embodiment, a method of thermally regulating an optical system having a casing and a tunable refractive optical element mounted within the casing, generally referred to using the numeral 300, will now be described. In this embodiment, the tunable refractive optical element is favourably operable within a designated thermal operating range.

The method 300 commences at 302 and generally comprises the following steps in this embodiment: at 304, arranging a thermally conductive element to at least partially thermally contact the tunable refractive optical element; at 306, arranging an active heat transfer device at a distance from the tunable refractive optical element; at 308, thermally coupling a thermal transfer conduit between the active heat transfer device and the thermally conductive element; and at 310, selectively activating the active heat transfer device to transfer heat from the tunable optical refraction element via the thermally conductive element and the thermal transfer conduit to the active heat transfer device so as to maintain operation of the tunable refractive optical element within the designated thermal operating range.

In this embodiment of method 300, the casing of the optical system defines an optical channel therethrough, the tunable refractive optical element is operable to apply a tunable refraction along the optical channel and the active heat transfer device is located within the casing at a distance from the tunable refractive optical element. More specifically, in this embodiment, the optical channel comprises a viewing channel to an active digital display and the tunable refractive optical element variably refracts pixelated content projected by the active digital display. Indeed, in this embodiment, the tunable refractive optical element comprises a tunable liquid lens (“lens”) and the optical system comprises a light field refractor. In use, the hardware associated with the active digital display produces heat within the casing (as may the hardware associated with the lens generate heat itself) and the active heat transfer device at least partly compensates for operational heat generation.

At 304, the step of arranging the thermally conductive element to at least partially thermally contact the lens in this embodiment comprises at least partially circumscribing the lens, which is substantially cylindrical shaped and dimensioned, with a complementarily shaped and dimensioned thermally conductive element. More specifically, in this embodiment, the thermally conductive element comprises a copper ring which fully circumscribes or encases the lens.

At 306, the step of arranging an active heat transfer device at a distance from the lens comprises arranging all components of the active heat transfer device within the casing, including a thermoelectric Peltier cooling device (“Peltier device”) with a heat sink, a fan and a temperature sensor, in this embodiment. Notably, in this embodiment, the Peltier device and the fan are arranged distant from the lens, whereas the temperature sensor is arranged proximate the lens to measure its operating temperature. In this embodiment, the Peltier device comprises a heat absorption plate and a heat dissipation plate separated by a semiconductor layer, and the heat sink abuts the heat dissipation plate. At step 306, the fan is arranged proximate the heat sink (which abuts the heat dissipation plate) to facilitate heat dissipation or heat exhaustion. As noted, the fan is positioned at a distance from the lens so as to minimize vibrational or other interference with the lens performance. As noted, the temperature sensor is arranged within the casing and step 306 further includes configuring the temperature sensor to measure any one or both of: a current operating temperature of the lens and a casing temperature proximate the lens.

At 308, the step of thermally coupling the thermal transfer conduit between the active heat transfer device and the thermally conductive element specifically comprises thermally coupling the thermal transfer conduit to the heat absorption plate of the Peltier device. In this embodiment, the thermal transfer conduit comprises a thermally conductive pipe or rod, which is arranged along the optical channel of the casing.

At 310, the step of selectively activating the active heat transfer device comprises first configuring a control unit within the casing to activate and/or deactivate the active heat transfer device to maintain a current operating temperature of the tunable refractive optical element within the designated thermal operating range. In this embodiment, this specifically comprises configuring the control unit to receive from the temperature sensor within the casing a sensed operational temperature and programming the control unit to activate and/or deactivate the active heat transfer device in accordance with the sensed operational temperature and the designated thermal operating range. In this embodiment, the sensed operational temperature comprises a current operating temperature of the lens. When the current operating temperature of the lens is above the designated thermal operating range, the method comprises activating the heat transfer device to cool the lens. When the current operating temperature of the lens is within or below the designated thermal operating range, the method comprises deactivating the heat transfer device to cease cooling of the lens (thereby allowing the temperature to rise over time during operation of the optical system).

At 312, the method 300 ends in this embodiment when the optical system is switched off.

It is to be appreciated that various alternative embodiments of the method 300 are envisaged, without departing from the general nature and scope of the instant disclosure. Some of these embodiments or variations are briefly described hereunder, although embodiments or variations described with reference to system 100 above are omitted for the sake of brevity.

In other embodiments, configuring the control unit may comprise programming the control unit to activate and/or deactivate the active heat transfer device in accordance with a predefined thermal cycle. In some embodiments, the predefined thermal cycle may be based on the designated thermal operating range and any one or both of: an expected casing operational temperature range and an expected ambient temperature range.

In accordance with another exemplary embodiment of the present disclosure (not specifically shown), a use of a thermal regulation system in an optical system to selectively transfer heat from a tunable refractive optical element (“lens”) mounted within a casing to an active heat transfer device to maintain favourable operation of the lens within a designated (favourable) thermal operating range, will now be described.

In this particular embodiment, the lens comprises a tunable liquid lens and the casing defines an optical channel comprising a viewing channel to an active digital display, thereby forming a light field refractor. In use, the hardware associated with the active digital display produces heat within the casing and as such, the use of the thermal regulation system at least partly compensates for operational heat generation.

In this embodiment, the thermal regulation system comprises a thermally conductive element in thermal contact with the lens, and a thermal transfer conduit thermally coupled between the active heat transfer device and the thermally conductive element.

In this embodiment, the active heat transfer device comprises a thermoelectric cooling device and specifically, a Peltier device having a heat absorption plate and a heat dissipation plate separated by a semiconductor layer. In this embodiment, the heat absorption plate is arranged in thermal contact with the thermal transfer conduit. The Peltier device also comprises a heat sink abutting the heat dissipation plate, as well as a fan arranged proximate the heat dissipation plate (specifically abutting the heat sink) to facilitate heat dissipation. In this embodiment, the fan is located at a distance from the lens to minimize any vibrational or other interference with the lens performance.

In this embodiment, the thermal regulation system further comprises a temperature sensor configured to measure a current operating temperature of the lens, as well as a control unit operable to activate and/or deactivate the thermal regulation system in response to the current operating temperature obtained by the temperature sensor, so as to maintain the current operating temperature of the lens within the designated thermal operating range.

In accordance with another exemplary embodiment of the present disclosure (not specifically shown), a non-transitory computer-readable medium (“medium”) having computer-executable instructions (“instructions”) stored thereon to modulate a thermal regulation system of an optical system, will now be described.

In this embodiment, the instructions, upon implementation by a digital data processor, selectively activate an active heat transfer device to transfer heat from a tunable optical refraction element (“lens”) mounted within a casing of the optical system to a thermally conductive element arranged in thermal contact therewith, to a thermal transfer conduit in thermal coupling therewith, to the active heat transfer device, so as to favourably maintain operation of the lens within a designated (favourable) thermal operating range.

In this embodiment, the active heat transfer device comprises a thermoelectric Peltier cooling device (“Peltier device”) having a heat absorption plate and a heat dissipation plate separated by a semiconductor layer, with a heat sink abutting the heat dissipation plate. Instructions to selectively activate the Peltier device specifically comprise instructions to close an electric path through which electric current flows to the Peltier device, thereby activating it.

In this embodiment, the instructions further comprise instructions which, upon implementation by the digital data processor, receive from a temperature sensor within the casing a sensed operational temperature comprising any one or both of: a current operating temperature of the lens and a casing temperature proximate the lens. The instructions further comprise instructions which, upon implementation by the digital data processor, calculate an average temperature based on the sensed operational temperature over a predefined period of time. Furthermore, in this embodiment, the instructions further comprise instructions which, upon implementation by the digital data processor, activate and/or deactivate the active heat transfer device based on the sensed operational temperature (typically based on the average operational temperature) to maintain the lens within the designated thermal operating range.

In this embodiment, the medium and instructions are specifically configured to be implemented in respect of an optical system in the form of a light field refractor. As such, in this embodiment, the casing defines an optical channel therethrough and the instructions further comprise instructions which, upon implementation by the digital data processor, applies a tunable refraction along the optical channel.

It is to be appreciated that various alternative embodiments of the instructions stored on the medium are envisaged, without departing from the general nature and scope of the instant disclosure. One of these embodiments or variations are briefly described hereunder but others will be understood with reference to other embodiments or aspects disclosed herein, and are omitted for the sake of brevity.

In other embodiments, the medium may comprise instructions which, upon implementation by the digital data processor, activate and/or deactivate the active heat transfer device based on a predefined thermal cycle to maintain the lens within the designated thermal operating range.

It is to be appreciated that, whilst the embodiments disclosed herein pertain largely to cooling an optical system and/or a tunable refractive optical element, other embodiments of the systems and methods disclosed herein may be equally workable for heating the optical system and/or the tunable refractive optical element, with minor adjustments to circuitry and/or processing instructions. To provide some non-limiting examples, the systems and methods may be implemented to heat or warm the optical system and/or the tunable refractive optical element in order to reach a designated thermal operating range (such as where the ambient temperature is low or below freezing) and/or to prevent condensation forming on the tunable refractive optical element (or within the casing). The implementation of the systems and methods disclosed herein to apply heat to optical systems or components is intended to fall within the scope of the instant disclosure and specific description of such embodiments is omitted solely for the purposes of brevity. Furthermore, it is to be appreciated that the embodiments disclosed herein are also intended to capture thermal regulation or management of the optical system and/or the tunable refractive optical element, whereby the active heat transfer device and/or thermal transfer chain is operable to both heat and cool the relevant component(s), in response to sensed operational temperature and/or predefined thermal cycling.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

What is claimed is:

1. An optical system comprising:
a casing defining an optical channel therethrough;
a tunable refractive optical element mounted within said casing to apply a tunable refraction along said optical channel, wherein said tunable refractive optical element is favourably operable within a designated thermal operating range; and
a thermal regulation system, comprising:
an active heat transfer device;
a thermally conductive element dimensioned to at least partially contact said tunable refractive optical element in thermal coupling therewith; and
a thermal transfer conduit thermally coupled between said active heat transfer device and said thermally conductive element;
wherein said active heat transfer device is activated to selectively transfer heat from said tunable optical refraction element via said thermally conductive element and said thermal transfer conduit to said active heat transfer device so as to maintain favourable operation of said tunable refractive optical element within said designated thermal operating range.

2. The system of claim 1, wherein said active heat transfer device is located within said casing at a distance from said tunable refractive optical element.

3. The system of claim 1, wherein said tunable refractive optical element is substantially cylindrically shaped and dimensioned and said thermally conductive element complementarily shaped and dimensioned to at least partially circumscribe same.

4. The system of any one of claims 1 to 3, wherein said tunable refractive optical element comprises a tunable lens.

5. The system of claim 4, wherein said tunable lens comprises a tunable liquid lens.

6. The system of any one of claims 1 3, wherein said thermal transfer conduit comprises a fluid-circulating conduit.

7. The system of any one of claims 1 to 3, wherein said thermal transfer conduit comprises a thermally conductive pipe or rod.

8. The system of any one of claims 1 to 3, wherein said thermal transfer conduit is arranged along said optical channel of said casing.

9. The system of any one of claims 1 to 3, wherein said active heat transfer device comprises a thermoelectric cooling device.

10. The system of claim 9, wherein said thermoelectric cooling device comprises a Peltier device having a heat absorption plate and a heat dissipation plate separated by a semiconductor layer.

11. The system of claim 10, wherein said heat absorption plate is arranged in thermal contact with said thermal transfer conduit.

12. The system of either one of claim 10 or claim 11, wherein said active heat transfer device further comprises a fan arranged proximate said heat dissipation plate to facilitate heat dissipation.

13. The system of claim 12, wherein said active heat transfer device further comprises a heat sink arranged between said heat dissipation plate and said fan.

14. The system of either one of claim 12 or claim 13, wherein said fan is located at a distance from said tunable refractive optical element.

15. The system of any one of claims 1 to 3, wherein said active heat transfer device comprises liquid cooling device.

16. The system of any one of claims 1 to 3, wherein said thermal regulation system further comprises a temperature sensor configured to measure any one or both of a current operating temperature of said tunable refractive optical element and a casing temperature proximate said tunable refractive optical element.

17. The system of any one of claims 1 to 3, comprising a control unit operable to activate and/or deactivate said thermal regulation system to maintain a current operating temperature of said tunable refractive optical element within said designated thermal operating range.

18. The system of claim 17, wherein said control unit is operable to activate and/or deactivate said thermal regulation system in accordance with a predefined thermal cycle.

19. The system of claim 18, wherein said predefined thermal cycle is based on said designated thermal operating range and any one or both of: an expected casing operational temperature range and an expected ambient temperature range.

20. The system of claim 17, wherein said control unit is operable to activate or deactivate said thermal regulation system based at least in part on a sensed operational temperature received from a temperature sensor, said sensed operational temperature comprising any one or both of a current operating temperature of said tunable refractive optical element and a casing temperature proximate said tunable refractive optical element.

21. The system of any one of claims 1 to 3, wherein said optical channel comprises a viewing channel to an active digital display.

22. The system of claim 21, wherein said tunable refractive optical element variably refracts pixelated content projected by said active digital display.

23. The system of claim 21, wherein hardware associated with said active digital display in use produces heat within said casing and said thermal regulation system at least partly compensates for operational heat generation.

24. The system of any one of claims 1 to 3, wherein said optical system comprises a light field refractor.

25. A method of thermally regulating an optical system having a casing and a tunable refractive optical element mounted within the casing, the tunable refractive optical element being favourably operable within a designated thermal operating range, comprising:
arranging a thermally conductive element to at least partially thermally contact the tunable refractive optical element;
arranging an active heat transfer device at a distance from the tunable refractive optical element;
thermally coupling a thermal transfer conduit between said active heat transfer device and said thermally conductive element; and
automating selective activation said active heat transfer device to transfer heat from said tunable optical refraction element via said thermally conductive element and said thermal transfer conduit to said active heat transfer device to maintain favourable operation of said tunable refractive optical element within said designated thermal operating range.

26. The method of claim 25, wherein said active heat transfer device comprises a thermoelectric Peltier cooling device having a heat absorption plate and a heat dissipation plate separated by a semiconductor layer, and a heat sink abutting said heat dissipation plate.

27. The method of claim 26, wherein said thermally coupling said thermal transfer conduit comprises thermally coupling said thermal transfer conduit to said heat absorption plate.

28. The method of either one of claim 26 or claim 27, further comprising arranging a fan proximate any one or both of said heat dissipation plate and said heat sink to facilitate heat dissipation.

29. The method of claim 28, wherein said fan is positioned at a distance from the tunable refractive optical element.

30. The method of any one of claims 25 to 27, wherein said arranging said thermally conductive element to at least partially thermally contact the tunable refractive optical element comprises at least partially circumscribing a substantially cylindrical shaped and dimensioned tunable refractive optical element with a complementarily shaped and dimensioned thermally conductive element.

31. The method of claim 25, wherein said active heat transfer device comprises liquid cooling device.

32. The method of any one of claims 25 to 27, comprising arranging a temperature sensor within the casing and configuring said temperature sensor to measure any one or both of: a current operating temperature of the tunable refractive optical element and a casing temperature proximate the tunable refractive optical element.

33. The method of any one of claims 25 to 27, comprising configuring a control unit within the casing to automatically activate and/or deactivate said active heat transfer device to maintain a current operating temperature of the tunable refractive optical element within the designated thermal operating range.

34. The method of claim 33, wherein said configuring said control unit comprises programming said control unit to activate and/or deactivate said active heat transfer device in accordance with a predefined thermal cycle.

35. The method of claim 34, wherein said predefined thermal cycle is based on the designated thermal operating range and any one or both of: an expected casing operational temperature range and an expected ambient temperature range.

36. The method of claim 33, wherein said configuring said control unit comprises:
configuring said control unit to receive from a temperature sensor within the casing a sensed operational temperature; and
programming said control unit to activate and/or deactivate said active heat transfer device in accordance with said sensed operational temperature.

37. The method of claim 36, wherein said sensed operational temperature comprises any one or both of a current operating temperature of the tunable refractive optical element and a casing temperature proximate the tunable refractive optical element.

38. The method of any one of claims 25 to 27, wherein the casing defines an optical channel therethrough, the tunable refractive optical element is operable to apply a tunable refraction along said optical channel and said active heat transfer device is located within said casing at a distance from the tunable refractive optical element.

39. The method of any one of claims 25 to 27, wherein said tunable refractive optical element comprises a tunable liquid lens.

40. The method of any one of claims 25 to 27, wherein said thermal transfer conduit comprises any one or both of a fluid-circulating conduit and a thermally conductive pipe or rod.

41. The method of claim 38, wherein said thermal transfer conduit is arranged along said optical channel of the casing.

42. The method of either one of claim 38 or claim 41, wherein said optical channel comprises a viewing channel to an active digital display.

43. The method of claim 42, wherein said tunable refractive optical element variably refracts pixelated content projected by said active digital display.

44. The method of either one of claim 42 or claim 43, wherein hardware associated with said active digital display in use produces heat within the casing and wherein said active heat transfer device at least partly compensates for operational heat generation.

45. The method of any one of claims 25 to 44, wherein said optical system comprises a light field refractor or phoropter.

46. Use of a thermal regulation system in an optical system to selectively transfer heat from a tunable refractive optical element mounted within a casing to an active heat transfer device to maintain favourable operation of said tunable refractive optical element within a designated thermal operating range.

47. The use of claim 46, wherein said thermal regulation system comprises a thermally conductive element in thermal contact with said tunable refractive optical element.

48. The use of claim 47, wherein said thermal regulation system comprises a thermal transfer conduit thermally coupled between said active heat transfer device and said thermally conductive element.

49. The use of any either one of claim 47 or claim 48, wherein said tunable refractive optical element comprises a tunable liquid lens.

50. The use of any one of claims 46 to 48, wherein said active heat transfer device comprises a thermoelectric cooling device.

51. The use of claim 50, wherein said thermoelectric cooling device comprises a Peltier device having a heat absorption plate and a heat dissipation plate separated by a semiconductor layer, and a heat sink abutting said heat dissipation plate.

52. The use of claim 51, wherein said heat absorption plate is arranged in thermal contact with said thermal transfer conduit.

53. The use of either one of claim 51 or claim 52, wherein said active heat transfer device further comprises a fan arranged proximate any one or both of said heat dissipation plate and said heat sink to facilitate heat dissipation.

54. The use of claim 53, wherein said fan is located at a distance from said tunable refractive optical element.

55. The use of any one of claims 46 to 54, wherein said thermal regulation system further comprises a temperature sensor configured to measure any one or both of a current operating temperature of said tunable refractive optical element and a casing temperature proximate said tunable refractive optical element.

56. The use of claim 55, wherein said thermal regulation system further comprises a control unit operable to activate and/or deactivate said thermal regulation system to maintain said current operating temperature of said tunable refractive optical element within said designated thermal operating range.

57. The use of any one of claims 46 to 56, wherein said casing defines an optical channel comprising a viewing channel to an active digital display, wherein hardware associated with said active digital display produces heat within said casing, and wherein said use of said thermal regulation system at least partly compensates for operational heat generation.

58. The use of any one of claims 46 to 57, wherein said optical system comprises a light field refractor.

59. A non-transitory computer-readable medium having computer-executable instructions stored thereon to modulate a thermal regulation system of an optical system, whereby the instructions, upon implementation by a digital data processor, selectively activate an active heat transfer device to transfer heat from a tunable optical refraction element mounted within a casing of the optical system to a thermally conductive element arranged in thermal contact therewith, to a thermal transfer conduit in thermal coupling therewith, to said active heat transfer device, so as to maintain favourable operation of said tunable refractive optical element within a designated thermal operating range.

60. The medium of claim 59, wherein said active heat transfer device comprises a thermoelectric Peltier cooling device having a heat absorption plate and a heat dissipation plate separated by a semiconductor layer, and a heat sink abutting said heat dissipation plate, and wherein said selectively activating said thermoelectric Peltier cooling device comprises instructions to close an electric path through which electric current flows to said thermoelectric Peltier cooling device.

61. The medium of either one of claim 59 or claim 60, wherein said instructions further comprise instructions which, upon implementation by said digital data processor, receive from a temperature sensor within said casing a sensed operational temperature comprising any one or both of: a current operating temperature of said tunable refractive optical element and a casing temperature proximate said tunable refractive optical element.

62. The medium of claim 61, wherein said instructions further comprise instructions which, upon implementation by said digital data processor, activate and/or deactivate said active heat transfer device based on said sensed operational temperature to maintain said tunable refractive optical element within said designated thermal operating range.

63. The medium of either one claim 59 or claim 60, wherein said instructions further comprise instructions which, upon implementation by said digital data processor, activate and/or deactivate said active heat transfer device based on a predefined thermal cycle to maintain said tunable refractive optical element within said designated thermal operating range.

64. The medium of any one of claims 59 to 63, wherein said casing defines an optical channel therethrough and wherein said instructions further comprise instructions which, upon implementation by said digital data processor, applies a tunable refraction along said optical channel.

65. The medium of any one of claims 59 to 64, wherein said optical system comprises a light field refractor.

66. The system of any one of claims 1 to 24, wherein said thermally conductive element is dimensioned to at least partially circumscribe said tunable refractive optical element in thermal coupling therewith.
